(19) United States
(12) Patent Application Publication
(10) Pub. No.: US 2026/0117074 A1
(43) Pub. Date: Apr. 30, 2026

(54) SPRAYABLE JOINT FINISHING COMPOUND

(71) Applicant: United States Gypsum Company, Chicago, IL (US)

(72) Inventors: Tyler Jared KINCAID, Wheaton, IL (US); Rafael BURY, Wheeling, IL (US); Buddhabhushan Pundlik SALUNKHE, Chicago, IL (US); Hillary Suzanne LEACH, Bettendorf, IA (US); Justin Ray DELK, Festus, MO (US); Christopher James BOROVKA, Grayslake, IL (US); Naveen Kumar PUNATI, Kildeer, IL (US)

(21) Appl. No.: 19/197,063

(22) Filed: May 2, 2025

Related U.S. Application Data
(60) Provisional application No. 63/711,801, filed on Oct. 25, 2024.

(51) Int. Cl. C09D 5/02; C09D 7/40; C09D 7/43; C09D 7/45; C09D 7/61; C09D 7/65; C09D 121/02; E04B 1/68

(52) U.S. Cl. CPC C09D 5/021; C09D 5/022; C09D 5/027; C09D 5/028; C09D 7/43; C09D 7/45; C09D 7/61; C09D 7/65; C09D 7/70; C09D 121/02; E04B 1/6801

(57) ABSTRACT

Sprayable joint compound compositions, building construction assemblies and methods, including methods for finishing joint seams and methods for installing interior walls and ceilings, the sprayable joint compound compositions having a thixotropic property and the sprayable joint compound compositions comprising a combination of a thixotropic rheological modifier, a polyacrylic dispersant and a hydrophobic lightweight filler.

### REFERENCE TO RELATED APPLICATIONS

This application claims the benefit of priority to U.S. provisional patent application 63/711,801 filed Oct. 25, 2024, the entire disclosure of which is herein incorporated by reference in its entirety.

### TECHNICAL FIELD

This disclosure relates to building construction products, assemblies and methods, including sprayable joint compound compositions, methods for finishing joint seams and methods for installing interior walls and ceilings.

### BACKGROUND

Construction of interior walls commonly includes attaching (hanging) drywall panels which are flat panels composed of a gypsum core sandwiched between two paper sheets, to studs (a wood or metal frame) with screws or nails, including as described in U.S. Pat. Nos. 8,931,230, 11,002,010 and 11,702,373. Two adjacent drywall panels may be attached to a frame side-by-side in the same plane, forming a flat joint seam between the drywall panels.

Finishing a joint seam is a multi-step process which may take several days to complete. In order to produce a monolithic wall, a flat joint seam is often treated with a joint compound, a reinforcement tape may then be embedded into the joint compound, and several coats of a joint compound are then typically applied over the tape, one by one, after each of the previous coats has dried. These additional coats may have to be feathered out from the joint seam over the drywall panel in order to make the seam appear flat such that when installation is completed, the installed wall appears monolithic, and the joint seam is concealed as much as possible. Some drywall panels may meet at an angle, forming a corner. This corner joint seam may be finished by attaching a corner bead to the drywall panels with fasteners. The fasteners are then also concealed by applying one or more coats of a joint compound.

Finishing joint seams may be characterized as time-consuming in part because each joint compound coat has to dry before the next joint compound coat can be applied. Conventionally, at least one day may be needed for a coat to dry. Furthermore, applying a joint compound by conventional methods such as with a drywall trowel or knife may be physically taxing to a user, especially when working on a large installation project and/or in a dwelling with high vertical walls. Finally, after the applied joint compound dries, it may need to be sanded in order produce a wall with uniform and aesthetically pleasing appearance.

Joint compounds may be spray-applied in order to make the installation process less physically demanding for a user. A joint compound viscosity may need to be decreased before the joint compound can be applied by spraying, including as described in U.S. patent publication 2015/0284543. However, decreasing the viscosity may be problematic because a diluted joint compound may sag down on a vertical wall, causing an uneven surface and/or a drying time for the diluted joint compound may be increased, prolonging the joint seam finishing process even further.

Thus, there remains the need in the field for joint finishing compounds that can be spray-applied when finishing joint seams during drywall panel installation and which have an optimized drying time and good self-leveling, shrinkage and anti-sagging properties.

### SUMMARY

At least some of these needs are addressed by sprayable joint finishing compound compositions and methods according to this disclosure.

In one aspect, this disclosure relates to a sprayable joint compound composition comprising:
calcium carbonate;
a hydrophobic lightweight filler;
a thixotropic rheology modifier;
a polyacrylic dispersant;
a cellulosic thickener;
a binder;
a non-leveling agent; and
water.

Preferably, the sprayable joint compound composition may be fluid when agitated or under shear stress, but it returns to a more viscous state when the agitation or stress is removed, as determined by visual inspection.

In particularly preferred embodiments, the sprayable joint compound composition may comprise:
calcium carbonate in an amount of about 35 parts to about 70 parts by weight;
the hydrophobic lightweight filler in an amount of about 1 to about 20 parts by weight;
the rheology modifier in an amount of about 0.05 to about 5 parts by weight;
the polyacrylic dispersant in an amount of about 0.05 to about 3 parts by weight;
the cellulosic thickener in an amount of about 0.1 to about 5 parts by weight;
the binder in an amount from about 2 to about 50 parts by weight;
the non-leveling agent in an amount from about 0.5 to about 5 parts by weight; and
about 15 to about 60 parts by weight of water.

In some embodiments, the sprayable joint compound composition may include the hydrophobic lightweight filler which comprises expanded perlite.

In some embodiments, the sprayable joint compound composition may comprise the thixotropic rheology modifier which comprises microfibrillated cellulose having main fibrils bifurcated into one or more secondary fibrils of a smaller diameter at the main fibril ends. In further embodiments, the sprayable joint compound composition may further comprise silicate fibers, more preferably, the silicate fibers may include hydrated inverted ribbon polysilicate fibers.

In some embodiments of the sprayable joint compound composition, the polyacrylic acid-based dispersant may comprise one or more of the following: cross-linked acrylate copolymers of ethyl acrylate and methacrylic acid and/or cross-linked acrylic terpolymers of ethyl acrylate, methacrylic acid and nonionic urethane surfactant monomers.

In some embodiments, the binder may be a latex emulsion.

In particularly preferred embodiments, the sprayable joint compound composition may include a ready-mixed formulation.

In particularly preferred embodiments, the sprayable joint compound composition may have a dry shrinkage of less than 20%, calculated as percentage for a wet coating thickness.

In another aspect, this disclosure relates to a use of the sprayable joint compound composition and corresponding methods for finishing a joint seam, embedding a reinforcement tape, filling in a joint seam, incorporating a corner bead, for forming a textured finish on a surface, and/or for concealing one or more of nails, screws and/or fasteners, including the surfaces such as a drywall panel, fiber wall panel, cement, cinder block or plaster wall.

In yet another aspect, this disclosure relates to a method for installing an interior wall, the method comprising:
embedding a reinforcement tape into a joint seam between abutting drywall panels; and
spray applying one or more finishing coatings of the sprayable joint compound composition of this disclosure within the joint seam and over the adjacent drywall surface.

In embodiments, the method may further comprise applying the sprayable joint compound composition within the joint seam, prior to embedding the reinforcement tape. In some embodiments, the method may further comprise sanding the one or more finishing coatings. In embodiments, the method may be performed to produce a level 3, 4, or 5 drywall finish. In embodiments, the reinforcement tape may be fiberglass, cloth or paper reinforcing tape.

In yet another aspect, this disclosure relates to a wall assembly, comprising at least two abutting drywall panels affixed to a frame and at least one coating of the sprayable joint compound composition according to this disclosure being applied at least within a joint seam between the two abutting drywall panels.

### BRIEF DESCRIPTION OF THE DRAWINGS

FIG. 1 reports a comparative analysis for viscosity of the sprayable joint compound according to this disclosure versus a conventional lightweight joint compound or the conventional lightweight joint compound diluted to a sprayable viscosity.

FIG. 2 reports a comparative analysis measuring shrinkage as per ASTM C474-15 of the sprayable joint compound according to this disclosure versus a conventional lightweight joint compound or the conventional lightweight joint compound diluted to a sprayable viscosity.

FIG. 3 reports a comparative analysis measuring a drying rate of the sprayable joint compound according to this disclosure versus a conventional lightweight joint compound or the conventional lightweight joint compound diluted to a sprayable viscosity.

FIGS. 4A and 4B report micrographs showing that a self-leveling (anti-sagging) property of the joint compound according to this disclosure (FIG. 4B) has been improved in comparison to that of the conventional light weight joint compound diluted to a sprayable viscosity (FIG. 4A).

### DETAILED DESCRIPTION

In one aspect, this disclosure provides a sprayable joint compound composition with decreased shrinkage, improved self-leveling and anti-sagging properties, and a decreased drying time.

In another aspect, this disclosure provides methods for installation and repair of dry walls, and/or finishing joint seams, including when finishing flat and corner joint seams.

In this disclosure, “wt %” means percentage by weight. In this disclosure, all percentages and ratios are by weight, unless specifically stated otherwise.

In this disclosure, “parts by weight” specifies the relevant proportions of components by weight.

In this disclosure, “about” means a value plus/minus 10%. For example, “about 100” means 100±10 and “about 200” means 200±20.

In this disclosure, dynamic viscosity can be referred to simply as viscosity. In this disclosure, the viscosity is measured according to ASTM C474-15, Section 5 using a Brookfield R/S ST rheometer with a Type-A Pin, sample cup size of ½ pint and an RPM of 75 at 70 Fahrenheits (70° F.), as described in U.S. patent publication 2015/0284543. The measured units may be then converted from Brabender Units (BU) to centipoise (cP) which is a unit of measurement of dynamic viscosity, and which is equal to one-hundredth of a poise (1P=100 cP=1 g×cm⁻¹×s⁻¹). The viscosity of water at 70° F. is 1 cP. The lower the viscosity value, the less viscous the joint compound composition is.

In this disclosure, a “high-shear” viscosity refers to a viscosity as measured with application of shear forces and/or with agitation.

In this disclosure, “viscosity at rest” refers to a viscosity in the absence of shear forces.

In this disclosure, the term “composition” may be used interchangeably with the term “mixture” or “formulation.” Compositions in this disclosure may include dry powder formulations which do not comprise water or liquid components as well as compositions in liquid, slurry or paste form which comprise water and/or liquid components.

In this disclosure, “a dry joint compound composition” means that the composition does not contain aqueous water or liquid components. Preferably, the composition may be in powder form. However, a dry composition or dry mixture may have some moisture content and may contain compounds with bound water molecules.

In this disclosure, “dry component” means a component which does not comprise aqueous water or liquid additives. The dry component may have some moisture content and may contain bound water molecules.

In this disclosure “by wt % on a dry basis of the composition” means by weight of dry components, not including aqueous water or liquid components.

In this disclosure, a drywall panel may be referred interchangeably as a drywall, plasterboard, wallboard, or gypsum board. The drywall panel is composed of a gypsum core extruded between two sheets of paper, a facer and a backer. Typically, being rectangular in its shape, the drywall panel has two long surfaces, a first long surface covered with the facer paper sheet and the opposing second long surface covered with the backer cover sheet, for example as described in U.S. Pat. Nos. 11,002,010, 11,702,373 and/or 9,249,578.

In this disclosure, a joint seam may be referred interchangeably as “joint,” and it refers to a seam between two abating drywall panels being attached to a frame, including flat seams between drywall panels which are attached in the same plane, as well as corner seams between two drywall panels which are attached at an angle.

In this disclosure, the term “limestone” may be used interchangeably with calcium carbonate or CaCO₃.

In this disclosure, levels 0 (no treatment at all) through 5 (the highest level of finish) for drywall finish are as defined by the Gypsum Association and as stated in the Gypsum Association's “Recommended Levels of Finish for Gypsum Board, Glass Mat and Fiber-Reinforced Gypsum Panels.” (GA-214). The finish level generally corresponds with the number of applications of joint compound to seams, trims, and fasteners. Levels three, four, and five are typically used for occupied spaces within buildings. For single family homes, level 4 is the most common level that is implemented.

A level 4 drywall finish is typically a level used for walls to be painted or finished with some light texturing. In order to produce a level 4 finish after drywall panels are attached to a frame, they are taped with joint tape, all joint seams and angles (corners) are prepared with 3 layers of a joint compound and sanded. All screws, nails and accessories are also prepared with three coats of a joint compound.

Level five is less frequently used and usually requires application of a skim coat of a joint compound across the entire wall surface. At the level 5 finish, a wall of drywall panels is expected to have a smooth and uniform (monolithic) surface. Level 5 drywall finishing includes all steps of level 4 finish and further an additional step of applying a skim coat of a joint compound or primer coating evenly across the entire wall surface.

The sprayable joint compound compositions according to this disclosure are suitable for applications at all levels and in particular, for levels 3, 4 and 5.

In some embodiments, the sprayable joint compound compositions according to this disclosure can be made as a dry formulation to which water is added by a user. However, in preferred embodiments, the sprayable joint compound compositions according to this disclosure are ready-mixed, meaning that they are pre-mixed with water during manufacturing and are shipped and stored as a water-based (aqueous) mixture. In some embodiments, the sprayable joint compound compositions according to this disclosure may comprise from about 15 to about 60 parts by weight of water, preferably from about 20 to about 55 parts by weight of water and even more preferably from about 30 parts to about 45 parts by weight of water.

The sprayable joint compound compositions according to this disclosure are thixotropic, meaning that the sprayable joint compound compositions become more fluid (flowable) when agitated or under shear stress, and then sprayable joint compound compositions return to a more viscous state when the agitation or stress is removed. This change in viscosity can be observed at room temperature (70° F.).

A first necessary component in the sprayable joint compound compositions is calcium carbonate which may be supplied as limestone and/or other fillers, i.e. dolomite, gypsum, etc. In embodiments, the sprayable joint compound compositions may comprise from about 35 parts to about 70 parts by weight of calcium carbonate, preferably from about 40 parts to about 65 parts by weight of calcium carbonate, and more preferably from about 45 parts to about 60 by weight of calcium carbonate.

Preferred joint compound compositions according to this disclosure include drying-type joint compounds, meaning that the joint compound hardens by evaporation of water.

The sprayable joint compound compositions according to this disclosure comprise a unique combination comprising a hydrophobic lightweight filler, at least one thixotropic rheology modifier which may have a high-water retention capacity, and at least one polyacrylic dispersant, resulting in at least the following technical advantages.

First, the sprayable joint compound composition has a low viscosity under the high-shear conditions, but the viscosity quickly increases, at rest or under no-shear conditions, resulting in the sprayable joint compound composition being sprayable, while also having excellent anti-dripping, anti-sagging and self-leveling properties after being applied to a vertical surface, such as for example as to a joint seam and its adjacent drywall panels.

Second, the sprayable joint compound compositions are versatile and can be used for all drywall joint finishing steps, including to embed a reinforcement tape, to fill in a joint seam, to incorporate a corner bead and to conceal nails, screws and/or fasteners.

Third, the sprayable joint compound compositions are easy to spray, and they are also easy to sand, decreasing installation time.

Fourth, the sprayable joint compound compositions have a lower shrinkage, minimizing a number of coats that need to be applied in order to even the surface of the flat joint seam or to cover a corner bead. In some embodiments, only two, and preferably only one finishing coat may be needed, in order to flatten a joint seam with a drywall surface.

Fifth, the sprayable joint compositions may be formulated as pre-mixed formulations, minimizing the need for addition of water.

Suitable hydrophobic lightweight fillers according to this disclosure may include microspheres, such as for example as glass or ceramic hollow microspheres, polyolefin beads, soda lime boro-silicate glass bubbles as described in U.S. Pat. No. 8,931,230, and/or perlite, expanded perlite, including a coated expanded perlite. A particularly preferred hydrophobic lightweight filler is a silicone-coated expanded perlite, one embodiment of which is described in U.S. Pat. No. 4,454,267, but other expanded perlites may be also used. The hydrophobic lightweight filler may be used in any suitable amount. In some embodiments, the hydrophobic lightweight filler may be used in about 1 to about 20 parts by weight, preferably in about 1 to about 15 parts by weight, and more preferably in about 4 to about 10 parts by weight.

A third necessary component in the sprayable joint compound compositions according to this disclosure is a thixotropic rheology modifier which imparts a thixotropic property to the sprayable joint compound composition.

Preferably, the thixotropic rheology modifier may be hydrophilic and capable of retaining (binding) water molecules up to at least 1, 10, or even at least up to 20 times, up to 30 times, or at least up to 40 times its weight. The hydrophilic rheology modifier has a large active surface bearing multiple hydroxyl groups (OH) available for binding water molecules. The hydrophilic rheology modifier may be used in any suitable amounts. In some embodiments, the hydrophilic rheology modifier may be used in about 0.05 to about 5 parts by weight, and more preferably from about 0.1 to about 3 parts by weight, and most preferably from about 0.1 to about 1 part by weight.

One preferred hydrophilic rheology modifier according to this disclosure may include microfibrillated cellulose (MFC) which can be also referred to as nanocellulose. Microfibrillated cellulose comprises cellulose fibrils which may be processed by a specific mechanical and/or enzymatic treatment to increase the specific surface and to reduce a dimeter (cross-section) and length of cellulose fibers.

MFC fibrils preferably have a fibril diameter in the nanometer range and a fibril length in the micrometer range. These MFC fibrils may be referred to as nanofibrils or main fibrils. MFC can be produced as described in U.S. Pat. No. 4,374,702 by passing a liquid suspension of cellulose through a small diameter orifice in which the suspension is subjected to a pressure differential and a high velocity shearing impact, followed by a high velocity decelerating impact.

A particularly preferred MFC in the sprayable joint compound compositions may include microfibrillated cellulose in which at least some main fibrils have bifurcations into one or more, e.g. 2, 3, 4, 5 or more, secondary fibrils at their ends, wherein the secondary fibrils have a smaller diameter than the non-bifurcated main fibril, one embodiment of which is described in WO 2015/180844.

In some embodiments, the sprayable joint compounds may include needle-shaped silicate fibers which may be hydrated or otherwise chemically modified in order to provide a thixotropic property, and which can be used instead of or in addition to microfibrillated cellulose in small amounts, e.g. from about 0.05 to about 5 parts by weight.

Preferably, silicate fibers may be modified and in particular, they may be hydrated and/or have a high density of surface-active centers. In some preferred embodiments, the sprayable joint compound compositions may comprise inverted ribbon polysilicates having filamentous (needle-like) morphology, more preferably hydrated and having a high density of surface-active centers. In some embodiments, the sprayable joint compound compositions may comprise about 0.05 to about 5 parts by weight, and more preferably from about 0.1 to about 3 parts by weight, and most preferably from about 0.1 to about 1 part by weight of the needle-shaped silicate fibers, preferably inverted ribbon polysilicates having filamentous morphology, and most preferably inverted ribbon polysilicate magnesium fibers.

The fourth necessary component in the sprayable joint compound compositions is a polyacrylic dispersant which may have a molecular weight in the range from about 1,000 to about 100,000 Daltons, preferably about 5,000 to about 90,000 Daltons. Particularly preferred polyacrylic dispersants include cross-linked acrylate copolymers of ethyl acrylate and methacrylic acid, and/or cross-linked acrylic terpolymers of ethyl acrylate, methacrylic acid and nonionic urethane surfactant monomers, but a polyacrylic acid or its salt, e.g. sodium polyacrylate, can be also used. In embodiments, the sprayable joint compounds may comprise from about 0.05 to about 3 parts by weight of the polyacrylic dispersant, and preferably from about 0.05 to about 1 part by weight of the polyacrylic acid-based dispersant.

The sprayable joint compound compositions may further comprise a cellulosic thickener which is a different group of compounds from microfibrillated cellulose. The cellulosic thickeners may include a cellulosic ether. Suitable cellulosic thickeners may include, but are not limited to, methyl cellulose, carboxymethyl cellulose, hydroxyethyl cellulose, hydroxypropyl cellulose, hydroxypropyl methyl cellulose, hydroxyethyl methyl cellulose, ethyl hydroxyethyl cellulose and any combination thereof. In embodiments, the sprayable joint compound may comprise from about 0.1 to about 5 parts by weight of the cellulosic thickener, preferably from about 0.1 to about 3 parts by weight of the cellulosic thickener, and more preferably from about 0.1 to about 1 part by weight of the cellulosic thickener.

In addition to a cellulosic thickener or instead of the cellulosic thickener, the sprayable joint compound compositions may comprise one or more of synthetic thickeners which may include any of the following: modified alkali swellable emulsion (ASE); hydrophobically modified alkali swellable emulsion (HASE), and/or nonionic polyurethane associative thickeners (HEUR). In embodiments, the sprayable joint compound may comprise from about 0.1 to about 5 parts by weight of the synthetic thickener, preferably from about 0.1 to about 3 parts by weight of the synthetic thickener, and more preferably from about 0.1 to about 1 part by weight of the synthetic thickener.

Yet another component in the sprayable joint compound compositions is a binder which may be a polymeric binder, natural or synthetic starch, casein, or any combination thereof. Polymeric binders may include, but are not limited to, acrylic acid polymer, acrylic acid co-polymer, alkyd, polyurethane, epoxy, polyester, or any combination thereof. Preferred binders may include polyvinyl acetate, polyvinyl alcohol, ethylene vinyl acetate co-polymer, vinylacrylic co-polymer, styrenebutadiene, polyacrylamide, other acrylic polymers/co-polymers, and any combination thereof. Particularly preferred binders include latex emulsions which are emulsions of polymer particles in water.

In embodiments, the sprayable joint compounds may comprise from about 2 to about 50 parts by weight of the binder, and preferably from about 2 to about 40 parts by weight of the binder, and most preferably from about 2 to about 15 parts by weight of the binder.

The sprayable joint compounds compositions according to this disclosure may further comprise one or more of non-leveling agents. Preferred non-leveling agents may include, but are not limited to, one or more clays, talc, mica or any combination thereof. In some embodiments, the sprayable joint compound compositions may comprise about 0.5 to about 5 parts by weight, and more preferably from about 0.5 to about 3 parts by weight, and most preferably from about 0.1 to about 2 parts by weight of one or more of the non-leveling agents.

Preferred non-leveling agents may include one or more of the following clays: laponite, synthetic phyllosilicate, attapulgite clay, bentonite, illite, kaolin, sepiolite, or any combination thereof. In some embodiments, one or more clays can be used in combination with starch.

In embodiments, the sprayable joint compound compositions may further comprise one or more additives which can be added in small amounts, e.g. from about 0.1 wt % to about 5 wt %, and more preferably from about 0.25 wt % to about 3.5 wt %. Examples of additives may include, but are not limited to, a surfactant, a dust reducing additive, oil, wax, a non-ionic surfactant, defoamer, fungicide, bactericide, anti-freezing agent, a plasticizer, and one or more in-can preservatives.

It is preferred that the sprayable joint compound composition has a basic pH greater than 7, preferably of about 8 or higher, e.g., in the range from about 8 to about 10. In order to control the pH of the sprayable joint compound composition, one or more pH adjusters, including sodium hydroxide, ammonia, or tri-ethylamine (TEA), can be added to the sprayable joint compound composition in order to adjust pH as may be needed.

Referring to Table 1, it provides one preferred embodiment of the sprayable joint compound composition.

TABLE 1
Sprayable Joint Compound Composition

| | | | Range |
|---|---|---|---|
| | | | (Parts |
| | Chemical | | by |
| Component | Type | Percent | Weight) |
| Calcium Carbonate | Fillers | 53.69% | 35-70 |
| Micronized polymer fibers | Rheology | 0.12% | 0.1-3 |
| micronized fibers/ | modifier | | |
| inverted polysilicates | | | |
| Perlite | Hydrophobic | 6.20% | 1-20 |
| | lightweight | | |
| | filler | | |
| HEC (hydroxy-ethyl cellulose) | Cellulosic | 0.17% | 0.1-5 |
| | thickeners | | |
| Attapulgite clay | Magnesium | 1.06% | 0.5-5 |
| | aluminum | | |
| | phyllosilicate | | |
| Polyacrylic dispersant | Surfactant/ | 0.11% | 0.05-1 |
| | Dispersant | | |
| Latex emulsion | Binder | 3.36% | 2-50 |
| Hexahydro-1,3,5-tris(2- | Preservative | 0.19% | 0-2 |
| hydroxyethyl)-s- | | | |
| triazine preservative | | | |
| Water | Water | 35.01% | 15-60 |
| TOTAL | | 100% | |

Table 2 lists some technologically advantageous properties of the sprayable joint compound compositions and composition components which contribute to these technologically advantageous properties.

TABLE 2

| Properties | Technology Enablers |
|---|---|
| Shrinkage | Dispersant, rheology modifiers, |
| | hydrophobic lightweight fillers |
| Sprayability | Dispersant, rheology modifiers |
| Faster drying | Dispersant, rheology modifiers, |
| | hydrophobic lightweight fillers |
| Self-leveling | Dispersant, rheology modifiers |

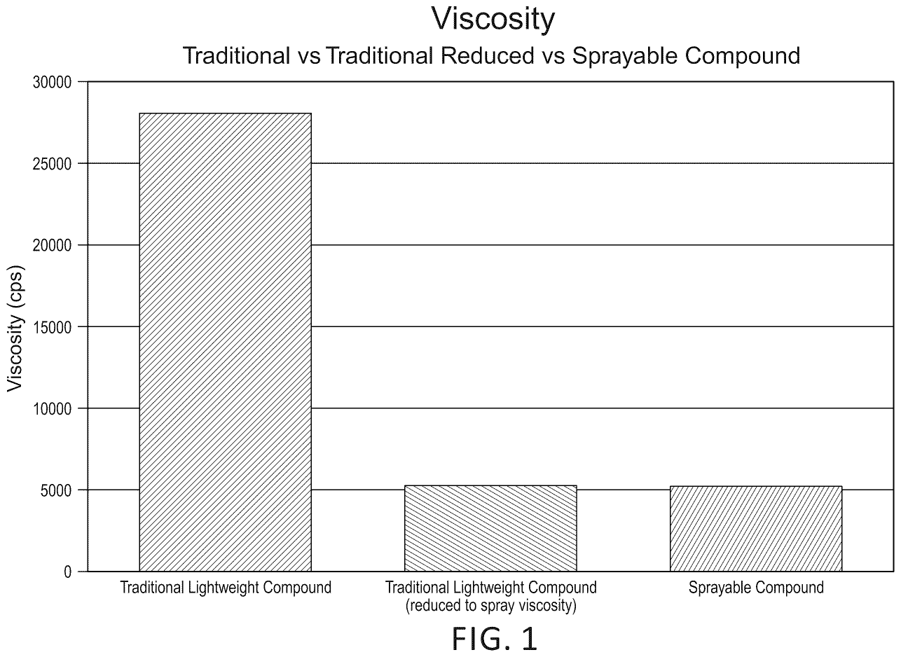

Some technological advantages of the joint compound compositions according to this disclosure will now be described with reference to FIGS. 1-3 and 4A and 4B.

FIG. 1 reports a comparative analysis of a viscosity of the sprayable joint compound composition according to this disclosure, prepared as per Table 1 in comparison to a conventional lightweight joint compound which does not comprise the thixotropic rheology modifier or polyacrylate dispersant as included in the sprayable joint compound compositions according to this disclosure. As can be seen in FIG. 1, the sprayable joint compound composition was prepared of about the same viscosity as the conventional lightweight joint compound diluted with water to the sprayable viscosity.

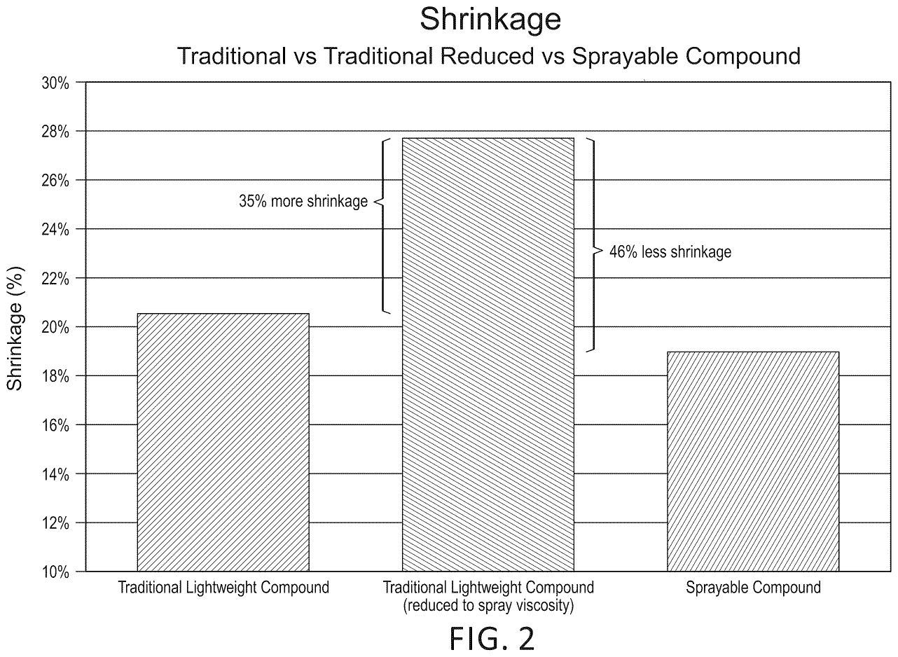

FIG. 2 reports that the shrinkage of the sprayable joint compound composition according to this disclosure was less than that of the conventional joint compound.

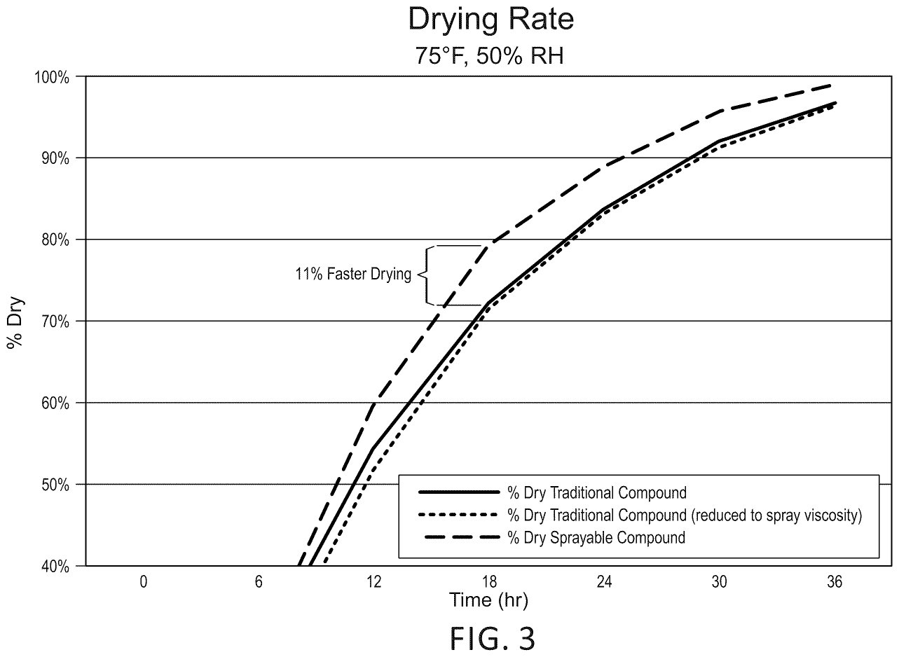

FIG. 3 reports that the drying rate of the sprayable joint compound composition according to this disclosure was faster than that of the conventional joint compound.

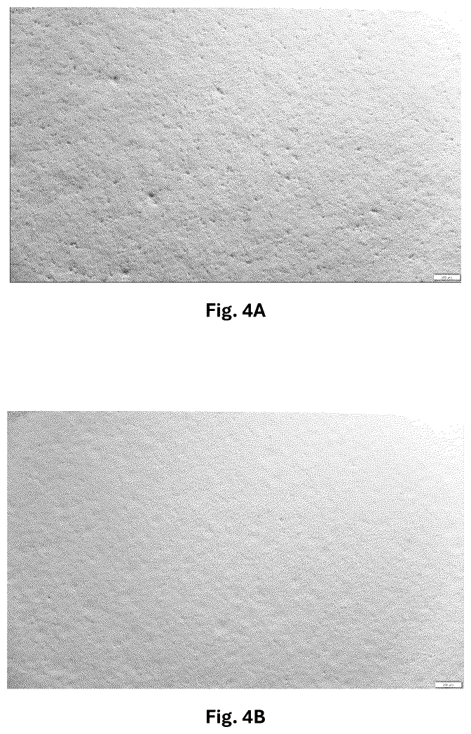

FIG. 4A is a micrograph showing a substrate coated with the conventional joint compound diluted with water for a sprayable application versus FIG. 4B is micrograph showing a substrate coated with the sprayable joint-compound composition according to this disclosure. As can be seen in the micrographs, the sprayable joint compound composition is self-leveling, providing for a smoother and more even surface.

In yet another aspect, this disclosure relates to methods for making ready-mixed joint compound compositions according to this disclosure. In some embodiments of the method, all liquid components may be first mixed in a mixer. After the mixing of liquid components is completed, dry components can be added to the mixer sequentially with continued mixing.

In yet another aspect, this disclosure relates to methods for building interior walls and interior wall assemblies, and in particular to methods for finishing joint seams, including flat seams and corners, between abutting drywall panels. The sprayable joint compound compositions are suitable for application with a texture sprayer, including airless texture sprayers, including Graco TexSpray Mark V sprayer from Graco Inc. USA, but a pump with a nozzle can be also used in some applications. But in some embodiments, the sprayable joint compound composition can be applied with a trowel, if needed.

The sprayable joint compound compositions according to this disclosure may be spray applied within a joint seam formed by abutting edges of drywall panels affixed to a frame. After that, a reinforcement tape can be embedded within the joint compound filled joint seam. Various reinforcement tapes may be suitable, including fiberglass, cloth or paper reinforcing tape. The sprayable joint compound composition can be also applied with a mesh and/or to a corner bead for corner joint seams.

After the applied joint compound coating dries, a second coating of the sprayable joint compound composition can spray-applied over the joint seam and some adjacent drywall surface and is allowed to dry in order to mask the tape and even the surface over the joint seam with the surface of the adjacent drywall panels. This finishing coating may be lightly sanded before a third finishing coating of the sprayable joint compound is spray-applied and sanded again after it is dried. One of the technical advantages of the sprayable joint compound according to this disclosure is that it has a lower shrinkage, meaning that it can be applied in fewer finishing coats, e.g. only in one or only two, or only three finishing coats, including for level 2, 3 or 4 finishes.

The sprayable joint compound composition may be useful as an all-purpose joint compound, meaning that it can be used for embedding a tape as well as for finishing joint seams. Yet, in some embodiments, the sprayable joint compound can be used in combination with a conventional all-purpose joint compound, wherein the conventional joint compound is used for embedding a tape, while the sprayable joint compound of this disclosure is used as a topcoat for finishing a joint seam and flatten it to the level of the abutting drywall panels.

The sprayable joint compound composition can be applied in some embodiments as a coating having a wet thickness during application of about 5 to about 100 mils, for example, at least 5 mil, at least 10 mil, at least 20 mil, at least 30 mils, at least 40 mils, at least 50 mils, at least 60 mils, at least 70 mils, less than 60 mils, less than 50 mils, or less than 40 mils.

After the sprayable joint compound composition was applied to a surface as a coating and dried, the coating thickness may shrink because water evaporates during drying. In some embodiments, the coating thickness may shrink by about 10%, about 20%, about 30% or about 40%, calculated as percentage from the thickness of the coating at the time of the application. In some preferred embodiments, the dried thickness and accordingly, coating shrinkage may be less than 20%, e.g. from about 10% to about 20% after the coating has dried.

In yet another embodiment, the sprayable joint compound composition can be used for applying to a drywall surface in order to form a textured finish to a surface, preferably to a drywall surface, and to create a pattern on the surface.

While one preferred substrate for sprayable joint compound compositions according to this disclosure is a drywall panel, the sprayable joint compound composition may be also used on other surfaces, including ceilings, fiber wall panels and plaster walls, as well as cement or cinder block.

We claim:

1. A sprayable joint compound composition comprising:
calcium carbonate;
a hydrophobic lightweight filler;
a thixotropic rheology modifier;
a polyacrylic dispersant;
a cellulosic thickener;
a binder;
a non-leveling agent; and
water.

2. The sprayable joint compound composition of claim 1, wherein the sprayable joint compound composition is fluid when agitated or under shear stress, and wherein the sprayable joint compound composition returns to a more viscous state when the agitation or stress is removed, as determined by visual inspection.

3. The sprayable joint compound composition of claim 1, wherein the sprayable joint compound composition comprises:
calcium carbonate in an amount of about 35 parts to about 70 parts by weight;
the hydrophobic lightweight filler in an amount of about 1 to about 20 parts by weight;
the rheology modifier in an amount of about 0.05 to about 5 parts by weight;
the polyacrylic dispersant in an amount of about 0.05 to about 3 parts by weight;
the cellulosic thickener in an amount of about 0.1 to about 5 parts by weight;
the binder in an amount from about 2 to about 50 parts by weight;
the non-leveling agent in an amount from about 0.5 to about 5 parts by weight; and
about 15 to about 60 parts by weight of water.

4. The sprayable joint compound composition of claim 1, wherein the hydrophobic lightweight filler comprises expanded perlite.

5. The sprayable joint compound composition of claim 1, wherein the thixotropic rheology modifier comprises microfibrillated cellulose having main fibrils bifurcated into one or more secondary fibrils of a smaller diameter at the main fibril ends.

6. The sprayable joint compound composition of claim 1, wherein the sprayable joint compound composition further comprises silicate fibers.

7. The sprayable joint compound composition of claim 6, wherein the silicate fibers include hydrated inverted ribbon polysilicate fibers.

8. The sprayable joint compound composition of claim 1, wherein the polyacrylic acid-based dispersant comprises one or more of the following: cross-linked acrylate copolymers of ethyl acrylate and methacrylic acid and/or cross-linked acrylic terpolymers of ethyl acrylate, methacrylic acid and nonionic urethane surfactant monomers.

9. The sprayable joint compound composition of claim 1, wherein the binder is a latex emulsion.

10. The sprayable joint compound composition of claim 1, wherein the sprayable joint compound composition is a ready-mixed formulation.

11. A method for finishing a joint seam, embedding a reinforcement tape, filling in a joint seam, incorporating a corner bead, for forming a textured finish on a surface, and/or for concealing one or more of nails, screws and/or fasteners, the method comprising applying the composition of claim 1 to the joint seam, the reinforcement tape, the joint seam, the corner bead, or over one or more of nails, screws and/or fasteners; and/or applying the composition to the surface and forming a textured finish on the surface.

12. The method of claim 11, wherein the surface is a drywall panel, fiber wall panel, cement, cinder block or plaster wall.

13. The sprayable joint compound composition of claim 1, wherein the sprayable joint compound composition has a dry shrinkage of less than 20%, calculated as percentage for a wet coating thickness.

14. A method for installing an interior wall, the method comprising:
embedding a reinforcement tape into a joint seam between abutting drywall panels; and
spray applying one or more finishing coatings of the sprayable joint compound composition of claim 1 within the joint seam and over an adjacent drywall surface.

15. The method of claim 14, wherein the method further comprises applying the sprayable joint compound composition within the joint seam prior to embedding the reinforcement tape.

16. The method of claim 14, wherein the method further comprises sanding the one or more finishing coatings.

17. The method of claim 14, wherein the method is performed to produce a level 3, 4, or 5 drywall finish.

18. The method of claim 14, wherein the reinforcement tape is fiberglass, cloth or paper reinforcing tape.

19. A wall assembly, comprising at least two abutting drywall panels affixed to a frame and at least one coating of the sprayable joint compound composition of claim 1 being applied at least within a joint seam between the two abutting drywall panels.
